(19) United States
(12) Patent Application Publication
(10) Pub. No.: US 2007/0021696 A1
(43) Pub. Date: Jan. 25, 2007

(54) Massaging apparatus and a method for improving human gland functioning

(76) Inventor: Sally Beckman, (US)

Correspondence Address: IRA J. NASSERIAN, Esq., SUITE 200, 2250 E. IMPERIAL HWY., EL SEGUNDO, CA, 90245, US

(21) Appl. No.: 11/187,653

(22) Filed: Jul. 22, 2005

(51) Int. Cl. A61H 7/00; A61H 19/00

(52) U.S. Cl. 601/134

(57) ABSTRACT

A foot massager has a plurality of bulges and the bulges are place on the surface of the bottom part of the apparatus. The device is used to improve proper functioning of human glands. There are known zones and nerve ending on the bottom of the human feet which are capable of sending energy signal to their corresponding gland. A bulge in contact with a targeted zone can send signal to a gland when a user apply pressure against the bulge.

### FIELD OF THE INVENTION

The present invention relates to a foot massaging device. There are a number of zones or nerve ending on the bottom of the foot which corresponds to a particular organ. Application of pressure to any zone or nerve ending send energy to organs corresponding to that targeted area. The user can target a single organ or a plurality of organs by using the map of the different zones on the bottom of the feet.

### BACKGROUND OF THE INVENTION

Drawings recovered form the work of the Ancient Egyptian shows people massaging each other feet. Eastern culture has been aware of relaxation points on the bottom of the human feet for over 4000 years. The existence of such zones has been well known by Chinese. According to the theory of Chinese traditional medicine, there are many acupuncture points in the foot and to press these acupuncture points may improve the blood circulation in the foot which is very healthy to the whole body.

Reflexology is a part of holistic including or involving all of something, especially all of somebody's physical, mental, and social conditions, not just physical symptoms, in the treatment of illness in body healing.

There is a strong belief that human feet are designed to walk on uneven surface and rough ground, thus massaging the bottom of our feet to keep human bodies healthy. Reflexology has been a well known practice in the old world and now is being investigated in the North America to heal myriad of diseases on the basis of the same premise.

Conventional foot-treatment and foot massagers do not offer controlled massaging devices that can target a particular area on the surface of the human feet. Therefore, it is desirable for people who suffer from illnesses that are caused by malfunctioning of a particular gland to target that gland and stimulate the gland resulting proper functioning.

### SUMMARY OF THE INVENTION

The present invention enables an owner of the massaging apparatus to improve the functioning of glands in his/her body at the comfort of home or while in place of work. An embodiment of the present invention enables the users of these apparatus to place their feet or one of their feet in the massaging apparatus and by moving their feet in different directions cause energy to be sent to a targeted gland and cause proper function of the.

The present invention discloses a method for causing proper functioning of human glands. The present invention allows a person who is diagnosed with an illness caused by improper functioning of a gland to send energy signals to that gland and thus stimulating that gland. The stimulated gland can in turn secrete the related hormone that is necessary of human functions. Furthermore, this invention is not only aimed to cause functioning of a gland but also improvement and enhancement of slow functioning glands.

In one embodiment of the present invention, a person who suffers from Diabetes first refers to a publicly available map of different zones or nerve endings on the bottom of human feet. It is well known that diabetes is a controlled illness and if controlled the affected person can have a normal life expectancy. It is also medically known that the illness is due to improper function of spleen which does not secrete insulin or if it dose secrete insulin the secretion is not responsive to the person's need. It is further known that secretion of insulin controls the blood sugar. Having the knowledge of these facts about the disease, a diabetic can cause the spleen to function and secrete insulin to the level sufficient to controls the blood sugar level. The diabetic by referring to the map of the zones and nerve ending can easily find out that the zone or the nerve ending corresponding to Spleen is located on the bottom of the left feet. The diabetics who own one of these apparatuses, which contain a plurality of spherical balls of different sizes, will place a spherical ball of appropriate size on the location within the box. The diabetic then can place his left foot such that the targeted zone or nerve ending will contact the selected spherical ball. The diabetic, then press his foot against that spherical ball and moves his/her feet in different direction while applying a vertical pressure on the bottom of his foot against the spherical ball. The stimulated zone or nerve ending sill send energy signal to spleen and stimulate the spleen to secret insulin. The time of this exercise can be determined by measuring sugar level in blood by different glucose measuring devices available in the market.

Furthermore, other embodiment of the present invention can improve functioning of other gland indicated on the map of zones on the bottom of human foot

### BRIEF DESCRIPTION OF THE DRAWINGS

FIG. 1 Prior Art is a publicly published zones or nerve endings on the bottom of human feet.

FIG. 2 is a block diagram of an exemplary foot massaging apparatus including an exemplary plurality of spherical balls.

FIG. 3 is a side view diagram of a foot massaging apparatus with a plurality of spherical balls.

FIG. 3 is a front view of an exemplary foot massaging apparatus.

FIG. 5 is a rear view of an exemplary foot massaging apparatus with a plurality of spherical balls.

### DETAILED DESCRIPTION OF THE INVENTION

Reference will now be made in detail to the preferred embodiments of the present invention, A MASSAGING APPARATUS AND A METHOD FOR IMPROVING HUMAN GLAND FUNCTIONING, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details. In other instances, well-known methods, procedures, components, and circuits have not been described in detail as not to unnecessarily obscure aspects of the present invention.

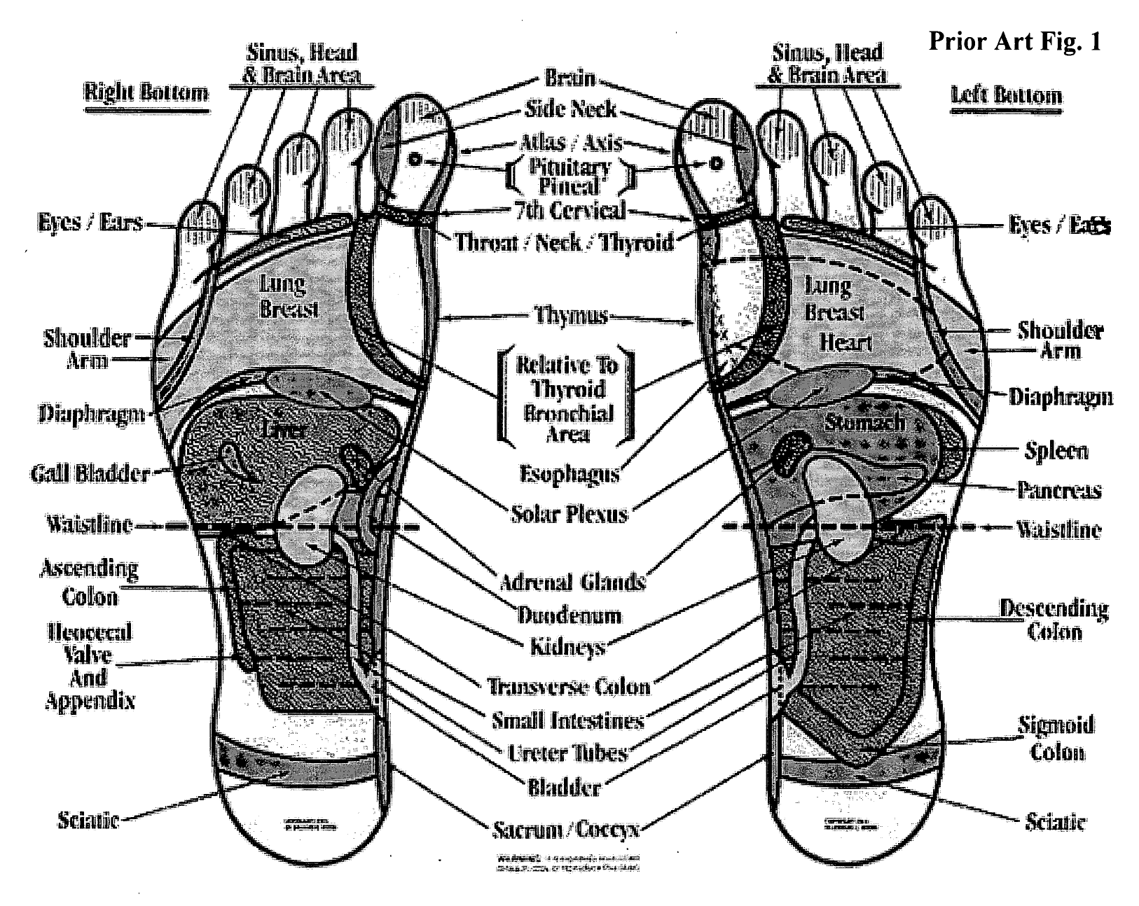

FIG. 1 Prior Art is a publicly published zones or nerve ending on the bottom of a human feet. The map is well known within the reflexology practitioner and acupuncturists. For example it is well accepted that the zone where nerve endings which correspond to the kidneys are located on both right and left feet each corresponding to the right and left kidney respectively. The zones relating to Sciatic are also located near the heals of the left and the right feet. A single zone which relates to the pancreas is located on the surface of the left feet.

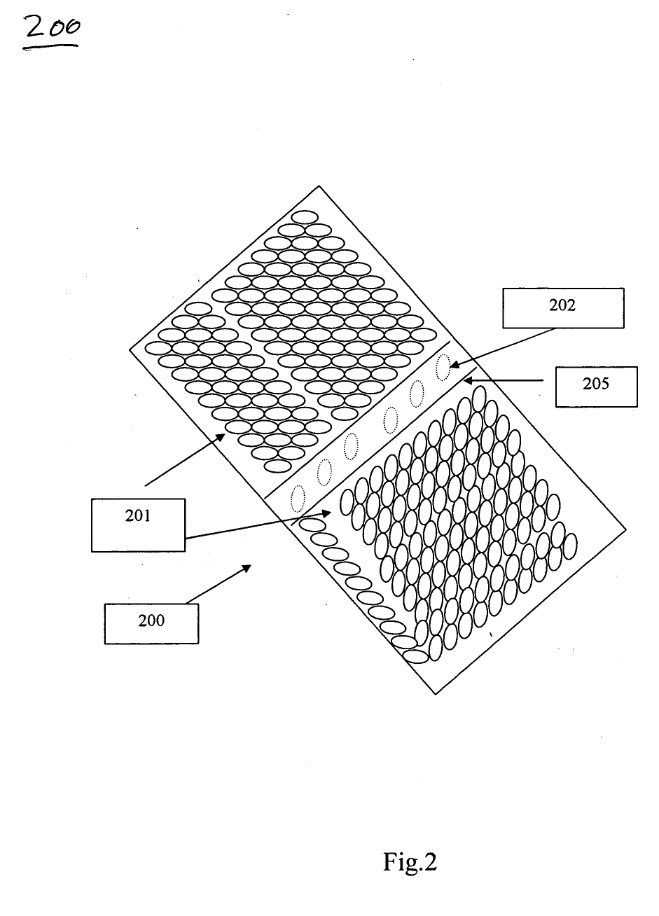

FIG. 2 is a block diagram of an exemplary foot massaging apparatus 200 including an exemplary plurality of spherical balls 201. The spherical balls 201 are loosely located on 10 the top surface of the bottom panel of the apparatus 200. The spherical ball 201 are similar in size in this embodiment of the present invention, however, in other embodiment of the present invention they may be of different sizes. In yet other embodiment of the invention, the spherical balls are larger when a zone in mid foot is to be stimulated. The size of the spherical balls used for stimulating the fore foot is smaller for practical purposes. The middle panel 202 has a plurality of wholes and spherical ball distributed evenly and are used for stimulating zones located on the side portion of the feet.

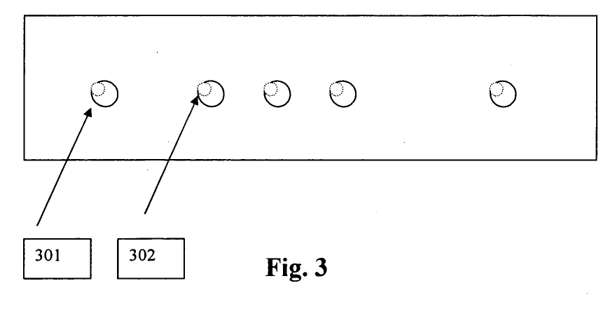

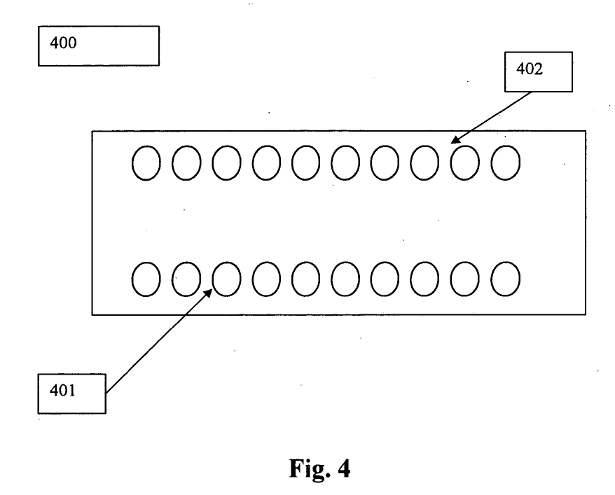

FIG. 3 is a side view diagram of a foot massaging apparatus 200 with a plurality of wholes and spherical balls 301 distributed evenly and are used for stimulating the zones on the outer side of the bottom of the foot.

FIG. 4 is a front view of an exemplary foot massaging apparatus. A plurality of spherical balls 402 are located on the upper part of the front part of the massaging apparatus 200 and a plurality of spherical balls are on the bottom part of the front part of the massaging apparatus 200. The plurality of spherical balls 402 are used to stimulate the zones on the top and arch of the feet.

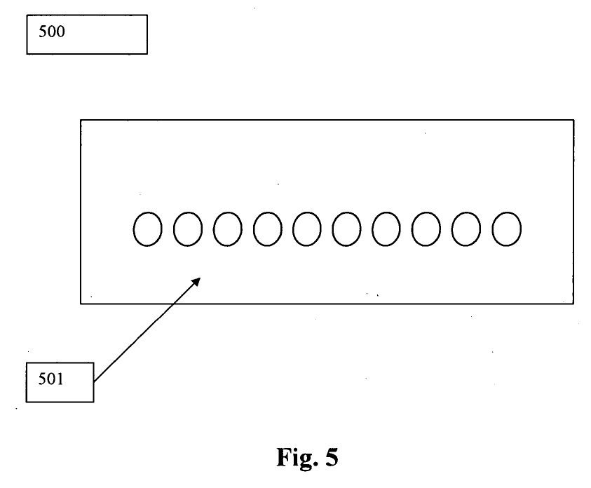

FIG. 5 is a rear view of an exemplary foot massaging apparatus with a plurality of spherical balls 501 and wholes are distributed evenly and are used for stimulating the zones on the hills and the rear part of human foot.

What is claimed is:

1. A foot massager comprising:
a casing having a left panel a right panel, a rear panel, a middle panel, and a bottom panel;
the bottom panel having a top surface and bottom surface;
the left panel having a front edge, a rear edge, an upper part and a lower part;
the right panel having a front edge, a rear edge, an upper part and a lower part;
the middle panel having a front edge, a rear edge, an upper part and a lower part;
the middle panel having an inside surface and an outer surface wherein a plurality of holes are well-distributed;
the left panel having an inside surface and an outer surface wherein a plurality of holes are well-distributed;
the right panel having an inside surface and an outer surface wherein a plurality of holes are well-distributed;
the rear panel having an inside surface and an outer surface wherein a plurality of holes are well-distributed;
the left panel, the right panel, the middle panel, the bottom panel, and the rear panel are tightly coupled;
a plurality of protuberance well distributed on the top surface of the bottom panel;
means for rotatably coupling the plurality of the protuberances to form a plurality of strings of protuberances each having an end one and an end two;
means for coupling the end one of at least one of the plurality of the strings to the inside surface of the left panel and the end two of the same at least one string to the inside surface of the right panel wherein the protuberances rest on the top surface of the bottom panel;
means for loosely coupling the end one of at least one of the plurality of the string of protuberances to the upper part of the inside surface of the left panel and the end two of the same at least one of the plurality of the string of protuberances to the upper part of the inside surface of the right panel.

2. A foot massager as described in claim 1 wherein the protuberances are spherical.

3. A foot massager as described in claim 2 wherein the protuberances are different sizes.

4. A foot massager as described in claim 1 wherein the protuberances are elliptical sphere.

5. A foot massager as described in claim 4 wherein the protuberances are different sizes.

6. A foot massager as described in claim 4 wherein the protuberances are made of plastics.

7. A foot massager as described in claim 4 wherein the protuberances are made of wooden material.

8. A foot massager as described in claim 1 wherein the protuberances are made of plastics.

9. A foot massager as described in claim 1 wherein the protuberances are made of glass.

10. A foot massager as described in claim 1 wherein the protuberances are made of plastics.

11. A foot massager as described in claim I wherein the foot massager is adopted to receive one foot.

12. A foot massager as described in claim I wherein the foot massager is adopted to receive two feet.

13. A foot massager as described in claim 1 that further comprises a middle panel having a plurality of whole and well the protuberances is placed between the right panel and the left panel.

14. A foot massager as described in claim I wherein the foot massager is adopted to be mounted on a plurality of rollers.

15. A method for providing massage treatment for the feet comprising the steps of:
a. Providing a massaging device having a plurality of protuberances of different sizes;
b. determining a target area on the surface of a user feet to be massaged;
c. finding an appropriate size protuberance from the plurality of protuberances of different sizes that can contact the target area of the bottom of user feet;
d. locating user feet inside the massaging device where the surface of the bottom of the feet rests on the plurality of the protuberance;
e. ensuring the target area on the surface of the feet contacts the appropriate size protuberance of the plurality of protuberances; and
f. moving the user feet in different directions ensuring enough perpendicular pressure is applied to the targeted area.

16. A method for providing massage treatement for the feet as described in claim 15 wherein the foot is moved longitudinally while user applies vertical pressure on the target area.

17. A method for providing massage treatement for the feet as described in claim 15 wherein the foot is moved sideways while the user applies vertical pressure on the target area.

18. A method for providing massage treatement for the feet as described in claim 15 wherein the foot is moved in a circular motion and while the user applies vertical pressure on the target area.

19. A method for providing massage treatement for the feet as described in claim 15 wherein the foot is moved in a circular motion and while the foot rests on the plurality of the protuberances.
